(19) United States
(12) Patent Application Publication
(10) Pub. No.: US 2003/0039517 A1
(43) Pub. Date: Feb. 27, 2003

(54) Knife-positioning washer for piloted router bit

(76) Inventor: Thomas H. Golding III, San Diego, CA (US)

Correspondence Address: CHARMASSON & BUCHACA, 1545 HOTEL CIRCLE SOUTH, SUITE 150, SAN DIEGO, CA, 92108-3412, US

(21) Appl. No.: 09/938,873

(22) Filed: Aug. 24, 2001

(51) Int. Cl. B23C 5/00; B23C 5/20

(52) U.S. Cl. 407/42; 407/53

(57) ABSTRACT

In a piloted router bit, the knife is conveniently aligned by positioning one of its edges against a spacer or washer interposed between the tool section of the router bit and its rotating bearing.

### FIELD Of THE INVENTION

This invention relates to tooling for machining and more particularly to piloted routers.

### BACKGROUND OF THE INVENTION

The wood manufacturing industry has used piloted insert router bits for decades. The router bit is an axially symmetric device comprising a center axle or shank extending into a tool upon which is mounted an interchangeable blade or knife. The pilot consists of at least one wheel or bearing which contacts and rolls along the edge of the work piece. The knives are subject to wear and must be periodically replaced when they become dull. It is important, however, to properly place new knives in the same position as old ones so that there is consistency in work product. For example, when a bead-forming bit which rounds the corner of a desk top is changed in the middle of a task, placing a new knife in a different position would create a different size bead requiring rerouting of the entire work piece.

It is of particular importance in two-knife bits to have both knives be properly positioned, otherwise a single knife will wear much quicker than the other. It is also desirable to be able to change knives without removing the bit from the chuck to save time. For those bits having a front bearing, removal of the bit from the router is even more time-consuming.

There is therefore, a need for an insert router bit which allows replacement of worn knives quickly and with proper accuracy and precision.

### SUMMARY OF THE INVENTION

The principal and secondary objects of this invention are to provide a piloted insert router bit which allows replacement of worn knives without removing the bit from the router while maintaining proper accuracy and precision of knife placement. These and other objects are realized by a router bit having a spacer or washer inserted between the tool and the bearing against which a forward portion of the knife can be accurately positioned.

### BRIEF DESCRIPTION OF THE DRAWING

FIG. 1 is a perspective view of a first piloted router bit according to the invention;

FIG. 2 is a half cross-sectional view taken along line 2-2 of FIG. 1;

FIG. 3 is a half cross-sectional view taken along line 3-3 of FIG. 1;

FIG. 4 is an elevational view of a second piloted router bit according to the invention;

FIG. 5 is a cross-sectional view taken along line 5-5 of FIG. 4; and

FIG. 6 is a half elevational view of a third piloted router according to the invention.

### DESCRIPTION OF THE PREFERRED EMBODIMENT OF THE INVENTION

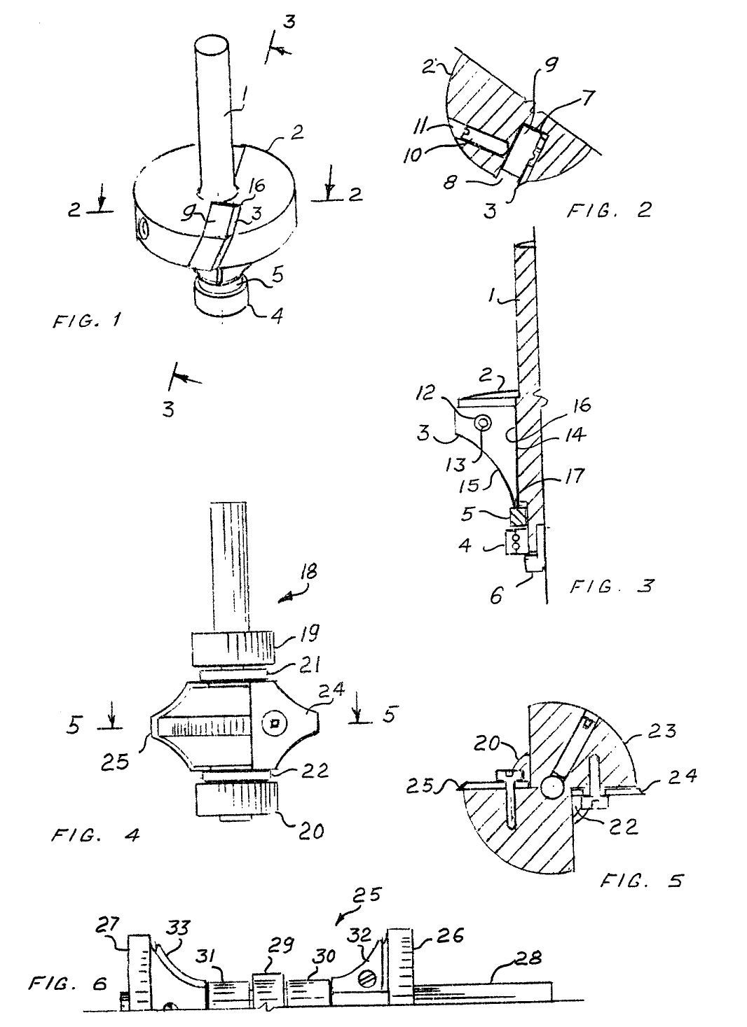

Referring now to the drawing, there is shown in FIG. 1, a first piloted router bit which comprises a shank 1 for attachment to the chuck of a router, a tool section or tool body 2 mounting a pair of knives 3 and a rotating bearing 4 at the distal end of the tool body coaxial with it and with the shank. A spacer such as a washer 5 is interposed between the distal end of the tool section and the bearing 4. The washer and the bearing 4 are retained by an axial screw 6 at the base of the tool. Each knife 3 is held against a slanted, radial mounting surface 7 of a slot 8 cut into the tool section. A clamping plate 9 holds the knife 3 against the mounting surface 7. The clamping plate is pressed by a screw 10 mounted in a threaded hole 11 bored through the tool section. One or more holes 12 in the blade are engaged by nibs 13 projecting from the clamping plate. The diameter of the knife hole 12 is larger than the diameter of the nib 13 allowing the blade to be adjustably positioned on the tool section. The lateral edge 14 of the knife opposite the cutting edge 15 bears against the ledge 16 formed by a corner of the slot 8. The distal axial end 17 of the knife rests against the spacer 5. Accordingly, when the knife is worn, a replacement one can be accurately mounted in the exact same cutting position against the ledge 16 and the spacer 5.

In the second piloted router bit 18 illustrated in

What is Claimed is: FIGS. 4 and 5, the pilot consists of two bearings 19, 20 mounted at the proximate and distal ends of the bit. A pair of washers 21, 22 are mounted astride the tool section 23 of the bit. The side of or one or both washers facing the tool section serves as mounting guide for the knives 24. In the third piloted router bit 25 illustrated in FIG. 6, two tool sections 26, 27 are mounted on the shank 28 in order to cut a bead along the two corners of a work piece edge simultaneously. The bearing 29 is mounted between the tool bodies, and a pair of spacers 30, 31 positioned on each side of the bearing provide a convenient aligning surface for the knives 32, 33 of the tool sections. The lengths of the spacers can also be used to determine the spacing between the two tool sections. It should be noted that in each case, the outer diameter of the spacer or washer must be lesser than the minimum radial extension of the knives. Furthermore, the spacer or washer needs not be allowed to rotate independently of the tool body and may not have a constant radius. While the preferred embodiments of the invention have been described, modifications can be made and other embodiments may be devised without departing from the spirit of the invention and the scope of the appended claims. What is claimed is:

1. A piloted router bit having a cutting direction and which comprises:
a shank for attachment to a router, said shank having an axis perpendicular to said cutting direction;
a tool section having a proximal end, a distal end and at least one surface positioned, shaped and dimensioned to mount a knife thereagainst;
a knife held against said surface, said knife having at least one cutting edge and at least one positioning edge substantially perpendicular to said axis;
at least one pilot comprising a rotating bearing coaxially mounted at one of said proximal and distal ends of the tool portion;
a spacer coaxially held between said pilot and said tool section; and
means for securing said knife against said surface with said positioning edge bearing against said spacer.

2. The router bit of claim 1, wherein said means for securing comprise a clamping plate pressing against said knife.

3. The router bit of claim 2, wherein said means for securing further comprise:
said knife having at least one hole therethrough of a first diameter; and
said clamping plate having a nib of a second diameter engaging said hole.

4. The router bit of claim, wherein said first diameter is larger than said second diameter;
whereby said knife can be adjustably positioned against said surface.

5. The router bit of claim 1, wherein said surface defines a ledge oriented, shaped and dimensioned to be abutted by a lateral edge of said knife opposite said cutting edge.

6. The router bit of claim 1, wherein said spacer consists of a washer.

7. In a piloted router bit including a replaceable knife having an axial edge, a tool section mounting a replaceable knife, and a pilot bearing coaxial with and proximal to, an axial end of said tool section, a knife-aligning improvement which comprises:
a spacer coaxially mounted between said tool section and pilot bearing, wherein the axial edge of said knife bears upon said spacer.

8. The improvement of claim 7, wherein said spacer has a lesser diameter than the smallest radial dimension of said knife.

9. The improvement of claim 8, wherein said spacer consists of a washer rotatably mounted in contact with said tool section.

10. A method for aligning a knife on a piloted router bit tool body having a bearing coaxially and rotatively mounted proximate to an axial end of said tool body, said method comprising inserting a spacer between said tool body and said bearing, and placing an axial end of said knife against said spacer.
